(19) United States
(12) Patent Application Publication
(10) Pub. No.: US 2023/0316207 A1
(43) Pub. Date: Oct. 5, 2023

(54) DEVICE, METHOD, AND COMPUTER-READABLE MEDIUM FOR ASSESSING INDIVIDUAL COMPLIANCE RISK

(71) Applicant: EUREKA FINTECH LIMITED, Tsim Sha Tsui (HK)

(72) Inventor: Hwa-Ping CHANG, Tsim Sha Tsui (HK)

(73) Assignee: EUREKA FINTECH LIMITED, Tsim Sha Tsui (HK)

(21) Appl. No.: 17/709,944

(22) Filed: Mar. 31, 2022

(51) Int. Cl. G06Q 10/06; G06Q 30/00

(52) U.S. Cl. CPC G06Q 10/06395; G06Q 30/018; G06Q 10/06393

(57) ABSTRACT

A device and a method for assessing individual compliance risk are provided, which is used to define a quantifiable indicator to calculate the anti-money laundering/know-your-customer (AML/KYC) compliance score of a specific individual, including: calculating a first score and a second score that are general and do not consider the relationship with an individual from a data source; filtering and calculating a compliance score related to the individual from the first score and the second score; and combining various compliance scores into a final individual compliance score. In addition, during the aggregation period of the above various compliance scores, corresponding calculation weights are given considering the influence of the person or company relative to the individual, so it can quickly and accurately reflect the compliance risk of the individual, and achieve the AML/KYC goal. A computer-readable medium for implementing the above method is also provided.

### BACKGROUND

### 1. Technical Field

The present disclosure relates to a data analysis technique, and more particularly, to a device, method, and computer-readable medium for assessing individual compliance risk.

### 2. Description of Related Art

The anti-money laundry/know your customer (AML/KYC) mechanism has become a global mainstream issue with the establishment of the Financial Action Task Force on Money Laundering (FATF). The International Monetary Fund (IMF) has also urged its 189 member countries to adhere to international standards to stop terrorist financing. However, there is no systematic, quantifiable way to measure compliance and the associated compliance risks with respect to specific individuals, other than sanctions lists issued by the United Nations, the United States Office of Foreign Assets Control (OFAC), the European Union and some countries. Currently, many financial institutions spend a lot of resources manually collecting data on customers' company background and their management teams, board members, shareholders, and even know your customer's customer (KYCC) data. This kind of KYC/KYCC monitoring and filtering is a necessary part of AML operations, but it has the following disadvantages: first, data sources vary by region and institution, and the amount of data is huge; second, there are currently no clear measuring standards for judging data other than sanctions lists, such as news or even social media data about companies, company executives and/or their supply chain partners. Consequently, the compliance results assessed by various financial institutions may vary widely. In addition, these financial institutions spend a lot of resources to produce compliance results, but these results have too many false triggers and thus waste a lot of manpower to achieve AML goals.

Therefore, there is a need for a solution to assess individual compliance risk, with simple and quantifiable metrics to assess the Anti-Money Laundering/Know Your Customer (AML/KYC) compliance score of a company, individual or transaction to effectively and quickly measure compliance risk, alert about specific individual risks and improve overall performance.

### SUMMARY

In order to solve the above problems, the present disclosure discloses a device for assessing individual compliance risk, comprising: a display module for providing an operation interface to receive investigation needs of an individual; a capture module for extracting data from a data source; a computing module for deriving a final individual compliance score from the data according to the investigation needs, wherein the computing module deriving the final individual compliance score comprises: causing the computing module to identify the individual according to the investigation needs, wherein the individual is one of a person, a company, or a financial transaction; causing the computing module to identify the individual's relevant persons and relevant companies; causing the computing module to calculate a person score of each of the relevant persons according to a person capture data in the data; causing the computing module to weight and average each of the person scores into a compliance score of a first item according to a first group of weights; causing the computing module to calculate a company score of each of the relevant companies according to a company capture data in the data; causing the computing module to weight and average each of the company scores into a compliance score of a second item according to a second group of weights; and causing the computing module to weight and average each of the compliance scores of the first item and the second item into the final individual compliance score according to a third group of weights.

In the above-mentioned device, a category of the first item includes a key person score, and the category of the first item defines a weighted average of the person score belonging to the category according to the first group of weights, the relevant person is one or more of the first chief executive officer, general manager, chief executive officer, senior manager, board member, company shareholder, company independent supervisor, representative of a subsidiary or investee company associated with the individual, and a weight value of each of the person score assigned by the first group of weights varies with an influence of each of the relevant persons relative to the individual in the category.

In the above-mentioned device, a category of the second item includes one or more of Sanctions Score, Enhanced Due Diligence (EDD) Score, News Score, Industry Score, National Score, Court Records Score, and Exchange Score for Initial Public Offerings (IPO), the category of the second item defines a weighted average of the company score belonging to the category according to the second group of weights, the relevant company is one or more of itself, parent company, subsidiary company, investee company, and supply chain partner associated with the individual, and a weight value of each of the company score assigned by the second group of weights varies with an influence of each of the relevant companies relative to the individual in the corresponding category and/or a level of involvement of the relevant person of the relevant company in the category.

In the above-mentioned device, the data source includes one or more of a network service and a database, and the data type includes one or more of the public information of the individual, various kinds of data of the individual provided by a data provider and know your customer data maintained by the user.

In the above-mentioned device, the computing module calculating the person score of each of the relevant persons according to the person capture data in the data comprises: obtaining the person capture data of an object of interest from the data source, wherein the object of interest is any one of each of the relevant persons; calculating various corresponding scores of the person capture data, wherein each category of the person capture data is one or more of news records, court records, social media, credit records, sanctions records, enhanced due diligence, politically exposed person certification, occupation and nationality; and weighting and averaging the various corresponding scores into the person score of the object of interest according to a fourth group of weights.

In the above-mentioned device, the computing module calculating the company score of each of the relevant companies according to the company capture data in the data comprises: obtaining the company capture data of an object of interest from the data source, wherein the object of interest is any one of each of the relevant companies; calculating a corresponding score according to a data coverage content of the company capture data under a definition content in the second item, wherein the definition content in the second item comprises any one of news records, court records, social media, financial records, sanctions records, enhanced due diligence, industry, country, and exchanges for initial public offerings; and taking the corresponding score as a company score of the object of interest under the second item.

In the above-mentioned device, the final individual compliance score is represented by a plurality of levels, and the display module is further used to visually inform a compliance risk of the individual in colors corresponding to the plurality of levels according to the final individual compliance score.

In the above-mentioned device, a weight value assigned by the third group of weights for each of the compliance scores of the first item and the second item varies with a degree of influence of the relevant person and the relevant company relative to the individual.

The present disclosure further discloses a method for assessing individual compliance risk, comprising steps of: receiving investigation needs of an individual by a display module; extracting data from a data source by a capture module; and deriving a final individual compliance score according to the investigation needs by a computing module, wherein the step of deriving the final individual compliance score by the computing module comprises substeps of: identifying the individual according to the investigation needs by the computing module, wherein the individual is one of a person, a company, or a financial transaction; identifying the individual's relevant persons and relevant companies by the computing module; calculating a person score of each of the relevant persons according to a person capture data in the data by the computing module; weighting and averaging each of the person score into a compliance score of a first item according to a first group of weights by the computing module; calculating a company score of each of the relevant companies according to a company capture data in the data by the computing module; weighting and averaging each of the company score into a compliance score of a second item according to a second group of weights by the computing module; and weighting and averaging each of the compliance scores of the first item and the second item into the final individual compliance score according to a third group of weights by the computing module.

In the above-mentioned method, a category of the first item includes a key person score, and the category of the first item defines a weighted average of the person score belonging to the category according to the first group of weights, the relevant person is one or more of the first chief executive officer, general manager, chief executive officer, senior manager, board member, company shareholder, company independent supervisor, representative of a subsidiary or investee company associated with the individual, and a weight value of each of the person score assigned by the first group of weights varies with an influence of each of the relevant persons relative to the individual in the category.

In the above-mentioned method, a category of the second item includes one or more of Sanctions Score, Enhanced Due Diligence (EDD) Score, News Score, Industry Score, National Score, Court Records Score, and Exchange Score for Initial Public Offerings (IPO), the category of the second item defines a weighted average of the company score belonging to the category according to the second group of weights, the relevant company is one or more of itself, parent company, subsidiary company, investee company, and supply chain partner associated with the individual, and a weight value of each of the company score assigned by the second group of weights varies with an influence of each of the relevant companies relative to the individual in the corresponding category and/or a level of involvement of the relevant person of the relevant company in the category.

In the above-mentioned method, the data source includes one or more of a network service and a database, and the data type includes one or more of the public information of the individual, various kinds of data of the individual provided by a data provider and know your customer data maintained by the user.

In the above-mentioned method, the step of calculating the person score of each of the relevant persons according to the person capture data in the data by the computing module comprises substeps of: obtaining the person capture data of an object of interest from the data source, wherein the object of interest is any one of each of the relevant persons; calculating various corresponding scores of the person capture data, wherein each category of the person capture data is one or more of news records, court records, social media, credit records, sanctions records, enhanced due diligence, politically exposed person certification, occupation and nationality; and weighting and averaging the various corresponding scores into the person score of the object of interest according to a fourth group of weights.

In the above-mentioned method, the step of calculating the company score of each of the relevant companies according to the company capture data in the data by the computing module comprises substeps of: obtaining the company capture data of an object of interest from the data source, wherein the object of interest is any one of each of the relevant companies; calculating a corresponding score according to a data coverage content of the company capture data under a definition content in the second item, wherein the definition content in the second item comprises any one of news records, court records, social media, financial records, sanctions records, enhanced due diligence, industry, country, and exchanges for initial public offerings; and taking the corresponding score as a company score of the object of interest under the second item.

In the above-mentioned method, a weight value assigned by the third group of weights for each of the compliance scores of the first item and the second item varies with a degree of influence of the relevant person and the relevant company relative to the individual.

In the above-mentioned method, further comprising: visually informing a compliance risk of the individual in colors corresponding to a plurality of levels according to the final individual compliance score by the display module.

The present disclosure further provides a computer-readable medium, which is applied to a computing device or a computer and stores instructions for executing the above-mentioned method for assessing individual compliance risk.

In summary, the present disclosure provides a device, a method and a computer-readable medium for assessing individual compliance risk, which are used to define a quantifiable indicator to quickly and accurately calculate the anti-money laundering/know-your-customer (AML/KYC) compliance score of a specific individual, and the process comprises: calculating from the data source the person score and company score that are general and do not consider the relationship with the individual; filtering out the person scores and company scores of relevant people and relevant companies that are related to the individual; calculating the compliance score for the person-wide compliance category and the company-wide compliance category in relation to the individual; and then combining the various compliance scores into the final individual compliance score. In addition, during the aggregation period of the above various scores, the corresponding calculation weights are given considering the influence of the person or company relative to the individual, so it can quickly and accurately reflect the individual compliance risk, achieve the AML/KYC goal, and improve the overall efficacy.

### BRIEF DESCRIPTION OF THE DRAWINGS

The embodiments disclosed in the present disclosure will be described in detail with the following drawings, and the explanations are shown in the following drawings.

FIG. 1 is a view showing a component configuration of a device for assessing individual compliance risk according to the present disclosure.

FIGS. 2 to 6 respectively disclose a partial implementation of a method for assessing individual compliance risk according to the present disclosure.

FIG. 7 is a flowchart illustrating steps of the method for assessing individual compliance risk according to the present disclosure.

### DETAILED DESCRIPTION OF THE EMBODIMENTS

The following describes the implementation of the present disclosure with examples. Those skilled in the art can easily understand other advantages and effects of the present disclosure from the contents disclosed in this specification. It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification, alteration or adjustment without affecting the possible effects and achievable proposes should still be deemed as falling within the scope defined by the technical contents disclosed in the present specification.

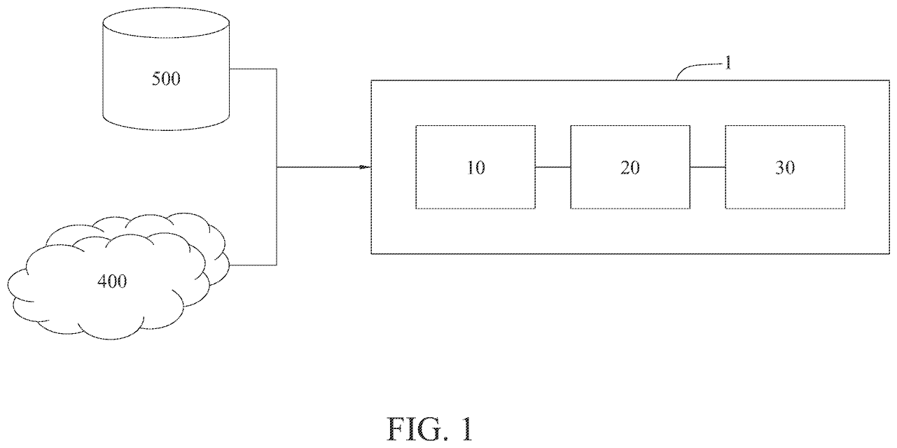

FIG. 1 is a schematic diagram showing a device 1 for assessing compliance risk of an individual and its configuration.

In an embodiment, the device 1 can be implemented by any computer device with computing functions, such as a desktop computer, a tablet computer, a smart phone, and the like. In an embodiment, the device 1 mainly includes a capture module 10, a computing module 20 and a display module 30, etc., and can communicatively connect with public or private data sources such as various network services 400 and a database 500 etc., so as to obtain the resources needed to assess an individual's compliance risk.

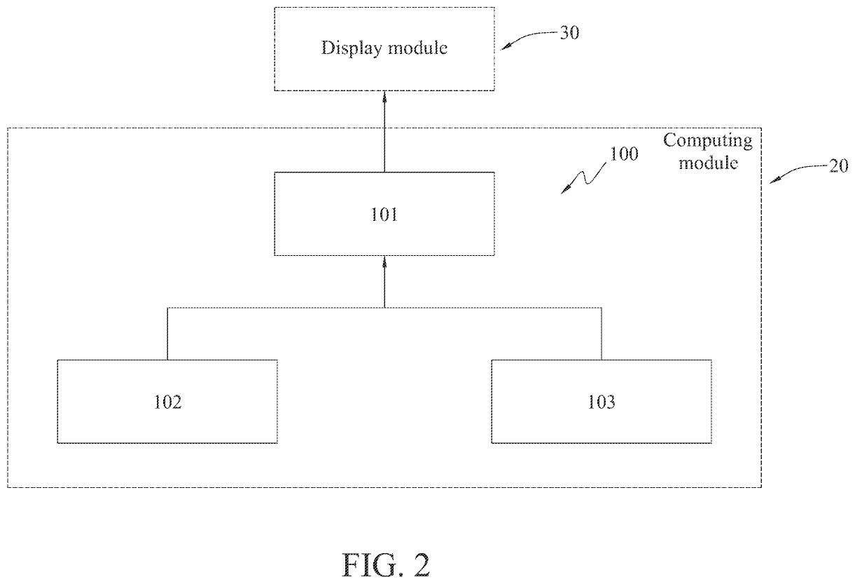

In some embodiments, the capture module 10 is used to extract data about the individual from the network services 400 and/or the database 500, the computing module 20 is used for sorting out a compliance score indicator 100 about the individual according to the data extracted by the capture module 10 (as shown in FIG. 2), and the display module 30 is used to provide a graphical user interface (GUI) for the user to view the compliance risk (the compliance score indicator 100) of the individual (for example, an operation interface is provided on the display of the device 1 for the user to select and investigate the compliance risk of the individual).

FIG. 2 is a diagram illustrating a composition of the compliance score indicator 100 to be derived by the above-mentioned device 1. As mentioned above, the compliance score indicator 100 is mainly sorted out in the computing module 20, and then displayed by the display module 30 at the user's request.

In an embodiment, the individual includes a company, a person, a transaction activity, etc., and the compliance score indicator 100 can be used in applications such as measuring a compliance score of money or virtual currency transactions based on individual characteristics, investigating client profiles to identify potential sanctions list persons and companies, and assessing the compliance risk of a company or person, etc., which are not limited herein.

In a further embodiment, the compliance score indicator 100 (and/or the above-described device 1 responsible for deriving the compliance score indicator 100) may be integrated with own operating procedures of any person, organization, system, software, online platform, etc. that needs to perform AML/KYC risk assessment for a specific individual. In detail, the users applicable to this compliance score indicator 100 include but are not limited to the following:
1. Global financial institutions or general companies that need to comply with AML/KYC;
2. Accounting firms, law firms, insurance companies, etc. that need to investigate customer backgrounds and risks or provide accounting reports or insurance policies before or after setting up a company account;
3. Public or private criminal investigation organizations and authorities; and
4. Supply chain partners that seek for a reliable compliance track record.

In some embodiments, the compliance score indicator 100 mainly describes that a final individual compliance score 101 of the individual to be investigated by the user is a result of a weighted average of the compliance scores related to this individual and belonging to a person-wide compliance category 102 and a company-wide compliance category 103 based on their respective assigned weights (hereinafter referred to as “a third group of weights”). For instance, the person-wide compliance category 102 refers to a category of compliance scores related to the individual's related persons, and the company-wide compliance category 103 refers to a category of compliance scores related to the individual's related companies.

In other embodiments, when calculating a final individual compliance score 101, the weight assigned to the compliance score belonging to the person-wide compliance category 102 or the company-wide compliance category 103, respectively, depends on the level of influence of the relevant person and/or relevant company involved in the above categories on this particular individual. Generally speaking, these weights (the third group of weights) can have preset values, but can also be adjusted by users according to their needs, which is not limited herein.

For example, when the individual to be investigated is a company, the compliance scores of the person-wide compliance category 102 may include: Key Person Score; and the compliance scores of the company-wide compliance category 103 may include: Sanctions Score, Enhanced Due Diligence (EDD) Score, News Score, Industry Score, National Score, Court Records Score, and Exchange Score for Initial Public Offerings (IPO) etc., the above compliance scores for this individual are assigned weights (the third group of weights) as follows:
Key Person Score: 20;
News Score: 20;
Industry Score: 5;
National Score: 5;
Court Records Score: 15; and
IPO Score: 5 etc.

The final individual compliance score 101 for this individual is a value obtained by weighting and averaging the scores for each of the above items based on their respective weights (the denominator is the sum of the above weighted values).

Additionally, the value of the aforementioned individual's final individual compliance score 101 may also be affected by the following factors, wherein this score may also change due to customer's needs and discussions:
Sanctions Score: If the individual is not on the sanctions list, the corresponding score is 1 and does not affect the final individual compliance score 101; if the individual is not on the sanctions list but has a sanction score of 5 for any of its key persons, supply chain, parent company or subsidiary company, the final individual compliance score 101 will be changed to 4; and if the individual is on the sanctions list, the corresponding score will be 5 and the final individual compliance score 101 will be changed to 5; and/or
Enhanced Due Diligence Score: If the subject is not on the EDD list, the corresponding score is 1 and does not affect the final individual compliance score 101; if the subject is not on the sanctions list but has an enhanced due diligence score of 5 for any of its key persons, supply chain, parent company or subsidiary company, the final individual compliance score 101 will be changed to 4; and if the individual is on the EDD list, the corresponding score will be 5 and the final individual compliance score 101 will be changed to 5.

It should be noted that when calculating the final individual compliance score 101, according to the type of the corresponding individual, the items included for calculating the compliance score are not limited to the above, and compliance scores for more or less items in the above categories and weights for different calculations may be included based on other important factors that may be considered later, which are not limited herein.

In a further embodiment, the final individual compliance score 101 is represented by a plurality of levels (e.g., levels 1-5). For example, level 1 indicates that this individual has the lowest AML/KYC risk; levels 2 to 3 indicate that this individual has a moderate AML/KYC risk; level 4 indicates that this individual has a high AML/KYC risk and needs to be warned about possible compliance risks, for example, there are too many civil court records or involving political figures, etc.; and level 5 indicates that the individual has a serious AML/KYC risk and may involve sanctioned people or companies, holding criminal court records, etc. Based on the above-described grading method of the final individual compliance score 101, a user using this compliance score indicator 100 can filter out individuals with high AML/KYC risk for relevant investigations.

In an additional embodiment, when the display module 30 displays the compliance score indicator 100 of the individual to be investigated according to the user's request, the level of the final individual compliance score 101 derived by the computing module can be displayed in different colors on the operation interface, so as to visually inform the user of the compliance risk of the individual to be investigated. For example, the display module 30 can mark an individual whose final individual compliance score 101 is level 1 to level 3 on the operation interface with blue, green and yellow respectively, indicating that this individual's AML/KYC risk is moderate or slight; mark an individual whose final individual compliance score 101 is level 4 on the operation interface with orange, indicating that this individual's AML/KYC risk is high; or mark an individual whose final individual compliance score 101 is level 5 on the operation interface with red, indicating that this individual's AML/KYC risks is serious. In this way, the user can quickly identify individuals with high AML/KYC risk for subsequent relevant investigations.

However, the grading method of the final individual compliance score 101 and the representation of the compliance score indicator 100 are not limited to the above, and can be divided into more or less grading according to job requirements, which are not limited herein.

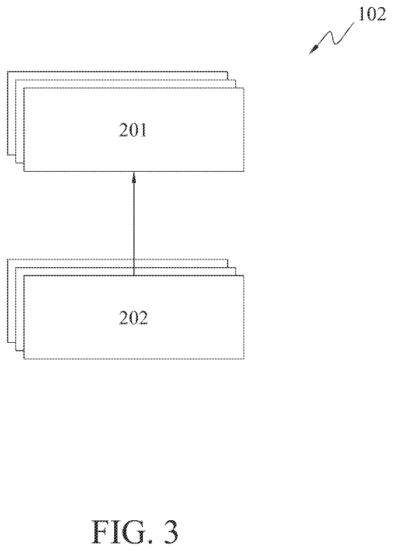

FIG. 3 illustrates how compliance scores belonging to the person-wide compliance category 102 are obtained. It should be noted that although it is not depicted in FIG. 3, persons with ordinary knowledge in the art should be appreciated that the calculation described in FIG. 3 is also implemented by the computing module 20 based on the relationship between the person-wide compliance category 102 and the final individual compliance score 101 in FIG. 2.

In an embodiment, items 201 for the compliance scores included in the person-wide compliance category 102 mainly include the key person score of the individual. In the embodiment where the queried individual is a specific company, the key persons of the individual include but are not limited to company members such as company officers (chief executive officer [CEO], general manager, executive director, senior managers, etc.), board members, company shareholders, company independent supervisors, representatives of subsidiaries or investee companies. However, the items 201 included in the person-wide compliance category 102 are not limited to the key person score, and other items 201 that can be included in the calculation can also be compiled (for example, calculating the compliance score of the persons related to the individual other than the company members), which is not limited herein.

Further, it can be seen from the relationship shown in FIG. 3 that the compliance scores of each item 201 are summarized from a plurality of person scores 202. For instance, the person scores 202 are compliance scores calculated for any person without considering the relationship with the individual (e.g., company), and the person scores 202 are expressed in the same grading manner as the final individual compliance score 101 (e.g., level 1 to level 5), and the calculation method of the person scores 202 will be described in more detail later. In the embodiment in which the item 201 represents the key person score, the computing module 20 may introduce a data processing mechanism to capture or filter from the person scores 202 the person score 202 of the relevant person (i.e., the key person) associated with the individual, and each filtered person score 202 (in this case, the key person score) is weighted and averaged after assigning respective weights (hereinafter referred to as the “first group of weights”) according to the influence (for example, the CEO generally has more influence on the company's business decisions than the shareholders) of the relevant persons relative to the individual in this item 201, and then the compliance score of the item 201 corresponding to the key person score can be obtained.

For example, when the individual to be investigated is a company and its key persons include a company officer, six company shareholders, five board members and an independent supervisor, a weight assigning method (the first group of weights) used to calculate the item 201 as “key person score” is as follows:
Company Officer: 50;
Board Members: 25;
Company Shareholders: 15; and
Independent Supervisors: 10, etc.

The item 201 representing the key person score is a value obtained by weighting and averaging (the denominator is the sum of the above weight values) the above-mentioned various person scores 202 based on their respective weights.

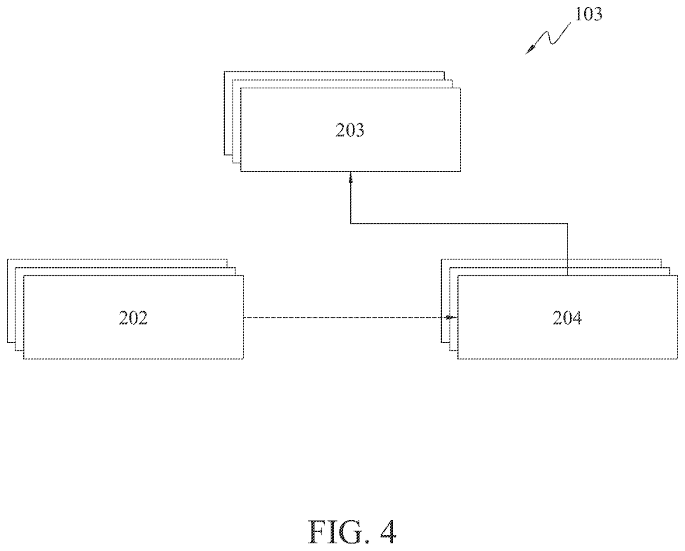

FIG. 4 illustrates how compliance scores belonging to the company-wide compliance category 103 are obtained. It should be noted that although it is not depicted in FIG. 4, persons with ordinary knowledge in the art should be appreciated that the calculation described in FIG. 4 is also implemented by the calculating module 20 based on the relationship between the company-wide compliance category 103 and the final individual compliance score 101 in FIG. 2.

In an embodiment, the items 203 for the compliance scores included in the company-wide compliance category 103 include, but are not limited to: sanctions scores, enhanced due diligence scores, news scores, industry scores, national scores, court records scores, exchange scores for IPOs and other compliance score items involving relevant companies related to individuals. In the embodiment in which the queried individual is a specific company, the relevant companies of the individual include but are not limited to the individual's own, parent company, subsidiary company, investee company, supply chain partner, and the like. However, the items 203 included in the company-wide compliance category 103 are not limited to the above, and other items 203 that can be included in the calculation can also be compiled (for example, the compliance scores are calculated based on social media or financial records operated by the individual's related companies), which is not limited herein.

Further, it can be seen from the relationship shown in FIG. 4 that the compliance scores of each item 203 are summarized from company scores 204. For instance, the company scores 204 are compliance scores corresponding to the items 203 defined by the company-wide compliance category 103 calculated for any company without considering the relationship with the individual (e.g., company), and the company scores 204 are expressed in the same grading manner as the final individual compliance score 101 (e.g., level 1 to level 5), and the calculation method of the company scores 204 will be described in more detail later. In some embodiments, the computing module may introduce a data processing mechanism to capture or filter from the company scores 204 the company scores 204 of the relevant companies that meet the definition of the item 203 and are associated with the individual, and each filtered company score 204 is weighted and averaged after assigning respective weights (hereinafter referred to as the “second group of weights”) according to the influence (for example, the parent company generally has more influence on the company's business decisions than its supply chain partners) of the relevant companies relative to the individual in the corresponding item 203, and then the compliance score of the corresponding item 203 can be obtained.

For example, when the individual to be investigated is a company, a weight assigning method (the second group of weights) of the company score 204 of each related company used to calculate item 203 as “news score” is as follows:
Parent Company: 60;
Self: 20; and
Subsidiaries: 20 etc.

The item 203 representing the news score is a value obtained by weighting and averaging (the denominator is the sum of the above weight values) the above-mentioned various company scores 204 based on their respective weights.

For another example, when the individual to be investigated is a company, a weight assigning method (the second group of weights) of the company score 204 of each related company used to calculate item 203 as “industry score” is as follows:
Parent Company: 25;
Self: 25;
Subsidiaries: 25; and
Supply Chain: 25 etc.

The item 203 representing the industry score is a value obtained by weighting and averaging (the denominator is the sum of the above weight values) the above-mentioned various company scores 204 based on their respective weights.

For a further example, when the individual to be investigated is a company, a weight assigning method (the second group of weights) of the company score 204 of each related company used to calculate item 203 as “court records score” is as follows:
Parent Company: 30;
Self: 60; and
Subsidiaries: 10 etc.

The item 203 representing the court records score is a value obtained by weighting and averaging (the denominator is the sum of the above weight values) the above-mentioned various company scores 204 based on their respective weights.

Furthermore, from the relationship shown in FIG. 4, it can be seen that each company score 204 is based on the degree of involvement in a definition content in the item 203 based on the composition of the company related personnel (for example, first CEO, general manager, CEO, senior managers, board members, company shareholders, company independent supervisors, etc. within the company) of the corresponding related company. Therefore, when using the company score 204 to calculate the compliance score of any item 203, the assigning of the weight may be affected by the person score 202 of the composition of the company related personnel.

For example, when the individual to be investigated is a company, each company score 204 used to calculate the item 203 as “sanction score” is based on the degree of involvement of the person in the corresponding company in the sanctions record (for example, the degree of involvement is determined according to the level of the person score 202), and the assigned weight will change accordingly.

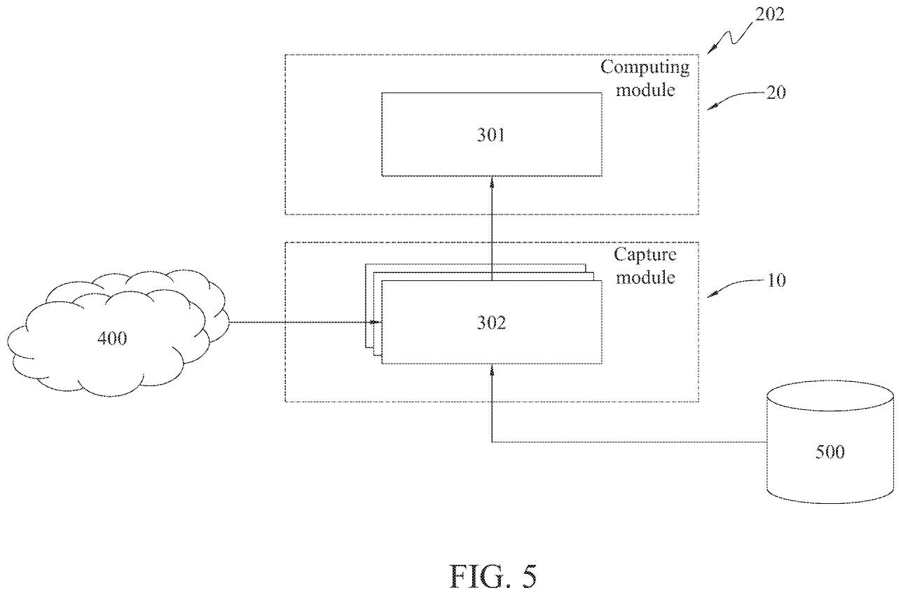

FIG. 5 discloses how the person score 202 is obtained. In an embodiment, the person score 202 is a general term for a plurality of general person scores 301, so the person score 202 and the general person score 301 can be referred to each other (e.g., in an interchangeable manner). As described above, the calculated general person score 301 (i.e., each person score 202) is expressed in the same grading manner as the final individual compliance scores 101 (e.g., level 1 to level 5).

It can be seen from the relationship described in FIG. 5 that the general person score 301 is mainly calculated by the computing module 20 according to a person capture data 302 from various data sources. In an embodiment, the data sources include two categories: a network service 400 and a database 500. Network service 400 is, for example, any online search engine, real-time/near-real-time streaming service, and other applications. Database 500 is, for example, a database of any data provider, open data of government agencies, etc., and the types of data provided by the data sources include but are not limited to: public information about individuals, public or non-public data of individuals provided by data providers, KYC information maintained by the individual, etc. In a further embodiment, the capture module 10 can use any suitable software application to extract a person capture data 302 about the object of interest from the various network services 400 and the database 500, and the computing module can assign corresponding scores (e.g., the same as the grading method of the final individual compliance score 101) according to the category of the person capture data 302, and the computing module 20 can then perform a weighted summation of the corresponding scores of each category of the person capture data 302 after assigning the corresponding weights according to the KYC conditions (e.g., factors such as occupational category, politically exposed persons, news record, nationality, blacklist research, social media analysis, etc.) of the object of interest itself, and then the general person score 301 of the object (i.e., a person score 202) can be obtained.

In detail, the category of the person capture data 302 affects the value of the general person score 301 according to the respective data coverage content. In some embodiments, the computing module 20 may use an artificial intelligence model to analyze the data coverage content of each category of the person capture data 302, so as to calculate the corresponding scores of each category. For example, the person capture data 302 belonging to the “news record” category corresponding to the object of interest can be counted (including but not limited to, using artificial intelligence modules to distinguish) and summarized according to the severity to calculate the corresponding score of the person capture data 302 belonging to the “news record” category of the object of interest. For another example, the person capture data 302 belonging to the “court records” category corresponding to the object of interest can be counted (including but not limited to, using artificial intelligence modules to distinguish) and summarized according to the severity to calculate the corresponding score of the person capture data 302 belonging to the “court records” category of the object of interest. Alternatively, for example, after analyzing (including but not limited to, using artificial intelligence modules to distinguish) keywords from the person capture data 302 belonging to the “court records” category corresponding to the object of interest, the corresponding score of the person capture data 302 belonging to the “court records” category of the object of interest can be summarized and calculated according to these keywords.

In some embodiments, the category of the person capture data 302 according to the data sources may include, but are not limited to, the following:
News Records: the source can be public online information obtained by any search tool (e.g., Google, Baidu, Yahoo, Bing, Yandex, etc.), including: online news, announcements, magazines, publications, etc.;
Court Records: the source may be public court records (e.g. court records database), including: civil judgment records, criminal judgment records, etc. published by local government authorities;
Social Media: the source can be publicly searchable social information, including: Facebook, Twitter, WeChat, etc., which can be used to measure relationships with subjects in social media networks in the presence of known criminal figures or criminal conduct;
Credit History: the source can be personal information submitted by any person to an assessment organization (for example, a bank or accounting firm) under local regulations for the purpose of financial transactions;
Sanctions Records: the sources may be public messages issued by the United Nations, governments, non-governmental organizations, etc. to warn known individuals or organizations of illegal activities;
Enhanced Due Diligence: most of the above categories are considered Customer Due Diligence (CDD) information. Enhanced due diligence (EDD) can provide a higher level of scrutiny of potential business partners and highlight risks that CDD information cannot detect; and
Politically Exposed Persons Certification: Politically Exposed Persons (PEPs) are high-risk clients under FATF standards because they are in a position that could be abused for money laundering purposes. Such persons are often required to provide proof of source of funds for this reason and can therefore be used as a source of proof for PEPs.

The corresponding scores of the categories of the above-mentioned person capture data 302 may be assigned different weights (hereinafter referred to as “fourth group of weights”) according to the own KYC conditions of the objects corresponding to the calculated general person scores 301. For example, when the object of calculating the general person score 301 is a shareholder of a company, the calculated general person score 301 will be calculated based on the corresponding scores of the following categories of person capture data 302 and the corresponding weights (the fourth group of weights):
News Record: 50; and
Court Records: 50 . . . etc.

The general person score 301 of the object is a value obtained by weighting and averaging (the denominator is the sum of the above weight values) the corresponding scores of the above-mentioned each category of person capture data 302 based on their respective weights.

In addition, the value of the general person score 301 of the above-mentioned object may also be affected by the following factors:
Sanction Record: if the object is not in the sanctions list, its corresponding score is 1 and does not affect the general person score 301; otherwise, its corresponding score is 5 and the general person score 301 will be changed to 5;
Enhanced Due Diligence: if the subject is not on the EDD list, the corresponding score will be 1 and the general person score 301 will not be affected; otherwise, the corresponding score will be 5 and the general person score 301 will be changed to 5; and/or
Politically Exposed Person Certificate: if the object is not a PEP, the corresponding score is 1 and does not affect the general person score 301; otherwise, the corresponding score is 4 and the general person score 301 will be the value of the original calculation result plus 1.

Understandably, depending on factors such as the object's occupation, the country where the household is registered, and the position of responsibility, it may lead to different correspondence between the object and the above categories, which in turn affects the assigning of weights, or considers other types of person capture data 302 as a calculation factor for the general person score 301. Therefore, persons with ordinary knowledge in the art should understand that the above-mentioned matching method of the weights and the categories of the person capture data 302 is used as an example, and is not intended to limit the scope of the present disclosure.

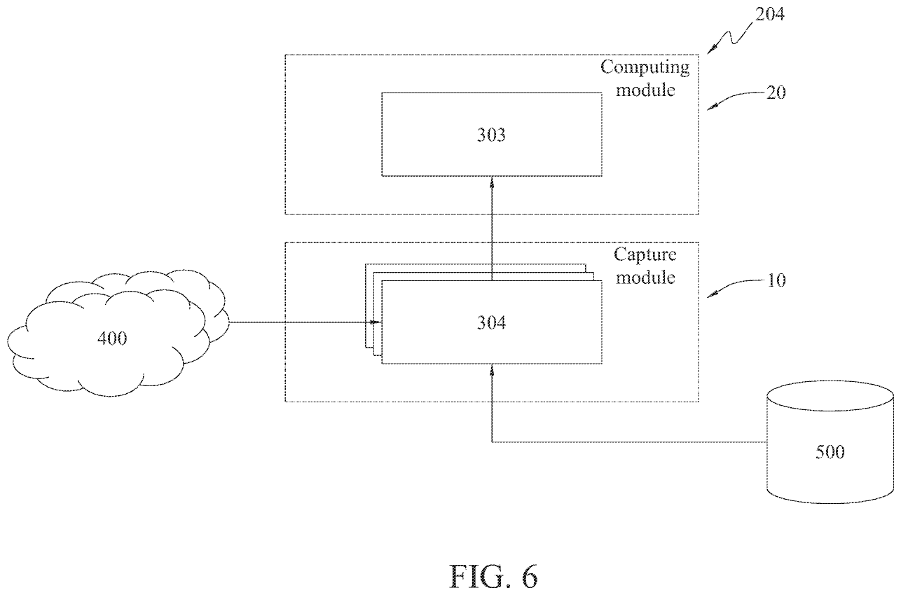

FIG. 6 illustrates how the company score 204 corresponding to the definition content in each item 203 is obtained. In an embodiment, the company score 204 is a general term for a plurality of general company scores 303, so the company score 204 and the general company score 303 can be referred to each other (e.g., in an interchangeable manner). As described above, the calculated general company score 303 (i.e., each company score 204) is expressed in the same grading manner as the final individual compliance scores 101 (e.g., level 1 to level 5).

As can be seen from the relationship described in FIG. 6, the general company score 303 is mainly calculated based on a company capture data 304 from various data sources, wherein the data sources (including the two major categories of the network service 400 and the public database 500) are similar or identical to those disclosed in FIG. 5, and therefore will not be described in detail. In a further embodiment, the capture module 10 can use any suitable software application to extract the company capture data 304 that meet the definition content in each item 203 and is related to the object of interest (in this case, any company) from various network services 400 and the database 500, and the computing module 20 can calculate a corresponding score from the obtained company capture data 304 as the general company score 303 of the object (i.e., a company score 204).

In detail, the company capture data 304 influences the value of the general company score 303 according to the data coverage content. In some embodiments, the computing module 20 can use the artificial intelligence model to analyze the data coverage content of each company capture data 304, so as to calculate the corresponding score, which is used as the general company score 303. For example, the company capture data 304 belonging to the “news record” category corresponding to the object of interest can be counted (including but not limited to, using artificial intelligence modules to distinguish) and summarized according to the severity to calculate the corresponding score of the company capture data 304 belonging to the “news record” category of the object of interest, which can be a candidate general company score 303 (a company score 204) that can be used to calculate the compliance score of any individual regarding the item 203 as “news score.” For another example, the company capture data 304 belonging to the “court records” category corresponding to the object of interest can be counted (including but not limited to, using artificial intelligence modules to distinguish) and summarized according to the severity to calculate the corresponding score of the company capture data 304 belonging to the “court records” category of the object of interest, which can be a candidate general company score 303 (a company score 204) that can be used to calculate the compliance score of any individual regarding the item 203 as “court records score.” Alternatively, for example, after analyzing (including but not limited to, using artificial intelligence modules to distinguish) keywords from the company capture data 304 belonging to the “court records” category corresponding to the object of interest, the corresponding score of the company capture data 304 belonging to the “court records” category of the object of interest can be summarized and calculated according to these keywords, which can be a candidate general company score 303 (a company score 204) that can be used to calculate the compliance score of any individual regarding the item 203 as “court records score.”

The company capture data 304 according to data sources may include, but are not limited to, the following:
News Records: the source can be public online information obtained by any search tool (e.g., Google, Baidu, Yahoo, Bing, Yandex, etc.), including: online news, announcements, magazines, publications, etc.;
Court Records: the source may be public court records (e.g., court records database), including: civil judgment records, criminal judgment records, etc. published by local government authorities;
Social Media: the source can be publicly searchable social information, including: Facebook, Twitter, WeChat, etc., which can be used to measure relationships with subjects in social media networks in the presence of known criminal figures or criminal conduct;
Financial Records: the source may be private or public financial information submitted by any company to an assessment organization (e.g., a bank or accounting firm) under local regulations for financial transaction needs;
Sanctions Records: the sources may be public messages issued by the United Nations, governments, non-governmental organizations, etc. to warn known individuals or organizations of illegal activities;
Enhanced Due Diligence: most of the above categories are considered Customer Due Diligence (CDD) information. Enhanced due diligence (EDD) can provide a higher level of scrutiny of potential business partners and highlight risks that CDD information cannot detect;
Industry: the source is the rating based on the financial risk of the industry in the local area after reference to the global risk assessment. For example, the non-metallic mining industry is considered to have a greater AML risk due to its involvement in a large number of jewelry transactions and difficult to monitor, while the banking industry is considered to have a lesser AML risk due to the very intense scrutiny of financial operations; and
Country: the source is based on the definition and score of the Corruption Perception Index. For example, North Korea, Afghanistan, Congo, Haiti and other countries are considered to be at risk of AML.

Understandably, with the additions, deletions or changes of the items 203 of the compliance scores included in the company-wide compliance category 103, the data sources of the above-mentioned company capture data 304 may change accordingly. Therefore, persons with ordinary knowledge in the art should understood that the types of data sources of the company capture data 304 described above are for illustrative purposes and are not intended to limit the scope of the present disclosure.

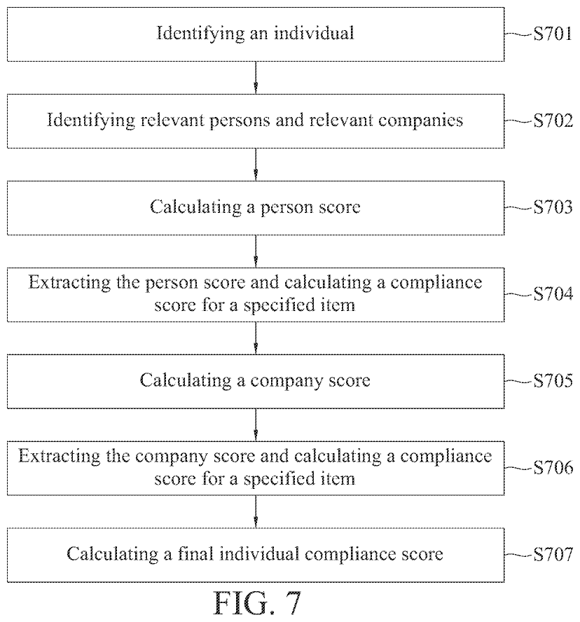

The above-mentioned FIGS. 2 to 6 disclose that when assessing the compliance score indicator 100 of a specific individual, it is necessary to consider various calculation factors from a general level (the composition of the final individual compliance score 101 as shown in FIG. 2) to a detailed level (the composition of the general person score 301 and the general company score 303 as shown in FIGS. 5 and 6). Referring now to FIG. 7 and the following description, the process steps for calculating the compliance score indicator 100 for a specific individual will be further understood.

It should be noted that the step process shown in FIG. 7 can be integrated with the self-operating procedures of any person, organization, system, software, online platform, etc. needing to perform AML/KYC risk assessment of a specific individual, so as to assess its compliance score indicator 100 for a specific individual.

At step S701, the device 1 confirms the individual to be inquired about the compliance score indicator 100 via an instruction submitted by a user at the display module 30. At this time, the individual may be any person, company, or financial transaction.

At step S702, the computing module 20 will further confirm the relevant person and the relevant company associated with the individual with respect to the confirmed individual, wherein the relevant person is related to a calculation of the compliance score of the item 201 defined by the person-wide compliance category 102, and the relevant company is related to a calculation of the compliance score of the item 203 defined by the company-wide compliance category 103.

At step S703, the computing module 20 together with the capture module 10 calculates the person score 202 from the person capture data 302 according to the confirmed relevant persons. At this time, the acquisition method of the person score 202 is as shown in FIG. 5.

At step S704, the computing module 20 further calculates the compliance score of the item 201 according to the extracted person score 202. For example, the person score 202 of each relevant person belonging to the key person of the individual can be weighted and averaged according to the respective assigned weights to obtain the compliance score of the item 201 belonging to the “key person score” in the person-wide compliance category 102.

At step S705, the computing module 20 together with the capture module 10 calculates the company score 204 from the company capture data 304 according to the confirmed related company. At this time, the acquisition method of the company score 204 is as shown in FIG. 6.

At step S706, the computing module 20 further calculates the compliance score of the item 203 according to the extracted company score 204. For example, each company score 204 about the news records of an individual's related company can be weighted and averaged according to the respective assigned weights to obtain the compliance score of the item 203 belonging to the “news score” in the company-wide compliance category 103. At this time, the company score 204 is affected by the person score 202, and its assigned weight may have different values according to the degree of involvement of the company related personnel of the corresponding company in the definition content in the item 203.

At step S707, the computing module 20 weights and averages the compliance scores of each item 201 in the person-wide compliance category 102 calculated in step S704 and the compliance score of each item 203 of the company-wide compliance category 103 calculated in step S706 to obtain the individual's final individual compliance score 101. At this time, the respective weights corresponding to the compliance scores of each item 201 or 203 may have different values depending on the degree of influence of the individual by the relevant person or company.

After the calculations in steps S701 to S707, the final individual compliance score 101 output by the computing module 20 can be effectively used to indicate the individual's AML/KYC risk (e.g., with green [corresponding to level 1] to red [corresponding to level 5] color change to visually indicate the individual's AML/KYC risk) via the display module 30, and the final individual compliance score 101 can also be used for follow-up applications related to mining and auditing such as audit tracking (audit trail)/data trail of the individual.

The present disclosure further discloses a computer-readable medium, which is applied to a computing device or computer having a processor (e.g., CPU, GPU, etc.) and/or memory, and stores instructions, and can utilize the computing device or the computer to execute the computer-readable medium via a processor and/or a memory, so as to execute the above steps when executing the computer-readable medium.

In conclusion, a device, a method and a computer-readable medium for assessing individual compliance risk disclosed in the present disclosure are used to define quantifiable indicators to quickly and accurately calculate an anti-money laundering/know-your-customer (AML/KYC) compliance score of a specific individual, and the process includes: calculating from the data source the person score and company score that are general and do not consider the relationship with the individual; filtering out the person scores and company scores of relevant people and relevant companies that are related to the individual; calculating the compliance score for the person-wide compliance category and the company-wide compliance category in relation to the individual; and then combining the various compliance scores into the final individual compliance score. In addition, during the aggregation period of the above various scores, the corresponding calculation weights are given considering the influence of the person or company relative to the individual, so it can quickly and accurately reflect the individual compliance risk, achieve the AML/KYC goal, and improve the overall efficacy.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection claimed by the present disclosure should be as described in the accompanying claims listed below.

What is claimed is:

1. A device for assessing individual compliance risk, comprising:
a display module for providing an operation interface to receive investigation needs of an individual;
a capture module for extracting data from a data source; and
a computing module for deriving a final individual compliance score from the data according to the investigation needs, wherein the final individual compliance score by the computing module comprises the steps of:
having the computing module identify the individual according to the investigation needs, wherein the individual is one of a person, a company, or a financial transaction;
having the computing module identify the individual's relevant persons and relevant companies;
having the computing module calculate a person score of each of the relevant persons according to a person capture data in the data;
having the computing module weigh and average each of the person scores into a compliance score of a first item according to a first group of weights;
having the computing module calculate a company score of each of the relevant companies according to a company capture data in the data;
having the computing module weigh and average each of the company scores into a compliance score of a second item according to a second group of weights; and
having the computing module weigh and average each of the compliance scores of the first item and the second item into the final individual compliance score according to a third group of weights.

2. The device of claim 1, wherein the computing module calculating the person score of each of the relevant persons according to the person capture data in the data comprises:
obtaining the person capture data of an object of interest from the data source, wherein the object of interest is any one of each of the relevant persons;
calculating various corresponding scores of the person capture data, wherein each category of the person capture data is one or more of news records, court records, social media, credit records, sanctions records, enhanced due diligence, politically exposed person certification, occupation and nationality; and
weighing and averaging the various corresponding scores into the person score of the object of interest according to a fourth group of weights.

3. The device of claim 1, wherein the computing module calculating the company score of each of the relevant companies according to the company capture data in the data comprises:
obtaining the company capture data of an object of interest from the data source, wherein the object of interest is any one of each of the relevant companies;
calculating a corresponding score according to a data coverage content of the company capture data under a definition content in the second item, wherein the definition content in the second item comprises any one of news records, court records, social media, financial records, sanctions records, enhanced due diligence, industry, country, and exchanges for initial public offerings; and
taking the corresponding score as a company score of the object of interest under the second item.

4. The device of claim 1, wherein the final individual compliance score is represented by a plurality of levels, and the display module is further used to visually inform a compliance risk of the individual in colors corresponding to the plurality of levels according to the final individual compliance score.

5. The device of claim 1, wherein a weight value of each of the person score assigned by the first group of weights varies with an influence of each of the relevant persons relative to the individual in the corresponding category, wherein a weight value of each of the company score assigned by the second group of weights varies with an influence of each of the relevant companies relative to the individual in the corresponding category and/or a level of involvement of the relevant person of the relevant company in the category, and wherein a weight value assigned by the third group of weights for each of the compliance scores of the first item and the second item varies with a degree of influence of the relevant person and the relevant company relative to the individual.

6. A method for assessing individual compliance risk, comprising steps of:
receiving investigation needs of an individual by a display module;
extracting data from a data source by a capture module; and
deriving a final individual compliance score according to the investigation needs by a computing module, wherein the step of deriving the final individual compliance score by the computing module comprises substeps of:
identifying the individual according to the investigation needs by the computing module, wherein the individual is one of a person, a company, or a financial transaction;
identifying the individual's relevant persons and relevant companies by the computing module;
calculating a person score of each of the relevant persons according to a person capture data in the data by the computing module;
weighing and averaging each of the person score into a compliance score of a first item according to a first group of weights by the computing module;
calculating a company score of each of the relevant companies according to a company capture data in the data by the computing module;
weighing and averaging each of the company score into a compliance score of a second item according to a second group of weights by the computing module; and
weighing and averaging each of the compliance scores of the first item and the second item into the final individual compliance score according to a third group of weights by the computing module.

7. The method of claim 6, wherein the step of calculating the person score of each of the relevant persons according to the person capture data in the data by the computing module comprises substeps of:
obtaining the person capture data of an object of interest from the data source, wherein the object of interest is any one of each of the relevant persons;
calculating various corresponding scores of the person capture data, wherein each category of the person capture data is one or more of news records, court records, social media, credit records, sanctions records, enhanced due diligence, politically exposed person certification, occupation and nationality; and
weighting and averaging the various corresponding scores into the person score of the object of interest according to a fourth group of weights.

8. The method of 6, wherein the step of calculating the company score of each of the relevant companies according to the company capture data in the data by the computing module comprises substeps of:
obtaining the company capture data of an object of interest from the data source, wherein the object of interest is any one of each of the relevant companies;
calculating a corresponding score according to a data coverage content of the company capture data under a definition content in the second item, wherein the definition content in the second item comprises any one of news records, court records, social media, financial records, sanctions records, enhanced due diligence, industry, country, and exchanges for initial public offerings; and
taking the corresponding score as a company score of the object of interest under the second item.

9. The method of claim 6, wherein a weight value of each of the person score assigned by the first group of weights varies with an influence of each of the relevant persons relative to the individual in the corresponding category, wherein a weight value of each of the company score assigned by the second group of weights varies with an influence of each of the relevant companies relative to the individual in the corresponding category and/or a level of involvement of the relevant person of the relevant company in the category, and wherein a weight value assigned by the third group of weights for each of the compliance scores of the first item and the second item varies with a degree of influence of the relevant person and the relevant company relative to the individual.

10. The method of claim 6, further comprising visually informing a compliance risk of the individual in colors corresponding to a plurality of levels according to the final individual compliance score by the display module.

11. A computer-readable medium for use in a computer storing instructions for performing the method of assessing individual compliance risk according to claim 6.
